(19) United States
(12) Patent Application Publication
(10) Pub. No.: US 2017/0057171 A1
(43) Pub. Date: Mar. 2, 2017

(54) PRINTING PLATFORM ADJUSTING SYSTEM AND ADJUSTING METHOD THEREFOR

(71) Applicant: Teco Image Systems Co., Ltd., Taipei City (TW)

(72) Inventors: Yu-Jen Chang, Taipei City (TW); Ken-Te Chou, Taipei City (TW); Ting-Chun Chen, Taipei City (TW); Chien-Ying Chen, Taipei City (TW)

(21) Appl. No.: 14/876,657

(22) Filed: Oct. 6, 2015

(30) Foreign Application Priority Data
Aug. 28, 2015 (TW) 104128378

(51) Int. Cl. B29C 67/00

(52) U.S. Cl. CPC B29C 67/0088; B29C 67/0092; B29C 67/0051; B33Y 30/00

(57) ABSTRACT

A printing platform adjusting system of a three-dimensional printer, and an adjusting method therefor are disclosed. The printing platform adjusting system includes a printhead, a supporting frame, a printing platform, a driving unit, a distance sensor, a control unit, and a parallelism adjusting set. The printing platform has a plurality of detecting points. The distance sensor is configured to detect and obtain a plurality of detected vertical height values corresponding to the detecting points. The control unit controls the driving unit to drive the printhead to move, receives the detected vertical height values from the distance sensor, and converts the detected vertical height values into a plurality of adjusted vertical height values. The parallelism adjusting set includes a plurality of adjusting and fastening units configured to adjust a degree of parallelism between the printing platform and the horizontal movement plane of the printhead according to the adjusted vertical height values.

### CROSS-REFERENCE TO RELATED APPLICATION

This application claims priority from Taiwan Patent Application No. 104128378, filed on Aug. 28, 2015, the entire contents of which are incorporated herein by reference for all purposes.

### FIELD OF THE INVENTION

The present invention relates an adjusting system and an adjusting method therefor, and more particularly to a printing platform adjusting system of a three-dimensional printer for adjusting a degree of parallelism between a printing platform and a horizontal movement plane of a printhead, and an adjusting method therefor.

### BACKGROUND OF THE INVENTION

In recent years, with the upgrading of industrial technology, the cost of three-dimensional printing is reduced and the three-dimensional printers become more common and public. In the conventional three-dimensional printer, a printing platform is fixed on the machine and parallel to a horizontal movement plane of the printhead for avoiding the running printhead to collide the printing platform or to scrape molding materials of printed models, and further preventing from causing damage to the printed products or even to the printhead. Therefore, the degree of parallelism of the printing platform relative to the horizontal movement plane of the printhead has to be adjusted after the three-dimensional printer is moved or before a printed model is printed.

However, the conventional printing platform adjusting method is performed by means of ocular estimating and manually producing. FIG. 1 illustrates a printing platform adjusting module of a three-dimensional printer according to the prior art. As shown in FIG. 1, the three-dimensional printer 1 includes a printhead 11, a printing platform 12, a supporting frame 13, a height adjusting set 14, and a plurality of adjusting screws 15. The supporting frame 13 is used to carry the printing platform 12. The printhead 11 driven by a driving unit is moved in a horizontal movement plane stably. However, the printing platform 12 is not parallel to the horizontal movement plane of the printhead 11, because of the slope difference between the supporting frame 13 and the printing platform 12, or different clearances between the connection corns of the supporting frame 13 and the printing platform 12. Under this circumstance, an adjustment operation needs to be performed to adjust the degree of parallelism between printing platform and the horizontal movement plane of the printhead. When the adjustment operation is performed, the supporting frame 13 is moved and adjusted by the height adjusting set 14, so that the supporting frame 13 with the printing platform 12 is moved close to the printhead 11. Then, the adjusting screws 15 are adjusted respectively by means of ocular estimating and manually producing for allowing the printhead 11 and the printing platform 12 to be in contact with each other or has a clearance equal to the height of a reference object (not shown). Afterward, the above step of adjusting the adjusting screws are repeated done for several times until the operator considers the process is accomplished by means of ocular estimating. Accordingly, in the prior art, the distance is estimated by human visual senses. The conventional printing platform adjusting process is more complicated, and it will take more time for adjusting. Certainly, the adjusting result is not precise.

Therefore, there is a need of providing a printing platform adjusting system in a three-dimensional printer for adjusting a degree of parallelism between the print platform and a horizontal movement plane of the printhead in order to overcome the above drawbacks encountered by the prior arts.

### SUMMARY OF THE INVENTION

An object of the present invention provides a printing platform adjusting system of a three-dimensional printer, and an adjusting method therefor. The inventive adjusting system and adjusting method can replace the prior adjusting means of ocular estimating and manually producing for adjusting a degree of parallelism between the print platform and a horizontal movement plane of the printhead, so as to solve the problems of complicated adjusting means, time-wasting adjusting process, and imprecise adjusting result, and further avoid to cause damage to the printed products or even to the printhead.

Another object of the present invention provides a printing platform adjusting system of a three-dimensional printer, and an adjusting method therefor. By using the adjusting system and adjusting method of the present invention, the degree of parallelism between the printing platform and the horizontal movement plane of the printhead is adjusted automatically or semi-automatically, so that the adjusting process is simplified, the adjusting time period is reduced, and the accuracy and precision of the adjustment operations is enhanced. In addition, the damage probability of the printhead can be reduced and the quality of the printed models can be enhanced.

A further object of the present invention provides a printing platform adjusting system of a three-dimensional printer, and an adjusting method therefor, in order to simplify the entire process of calculating the adjusting parameters and reduce the loading of the control unit.

In accordance with an aspect of the present invention, there is provided a printing platform adjusting system for a three-dimensional printer. The printing platform adjusting system includes a print unit having a printhead, a supporting frame, a printing platform, a driving unit, a distance sensor, a control unit, and a parallelism adjusting set. The printing platform is disposed on the supporting frame and has a plurality of detecting points. The driving unit is connected to the print unit and drives the printhead to move in a horizontal movement plane and in a vertical direction. The distance sensor is disposed on the print unit and configured to detect and obtain a plurality of detected vertical height values corresponding to the detecting points. The control unit is connected to the driving unit and the distance sensor, controls the driving unit to drive the printhead to move, receives the detected vertical height values from the distance sensor, and converts the detected vertical height values into a plurality of adjusted vertical height values. The parallelism adjusting set includes a plurality of adjusting and fastening units, wherein the adjusting and fastening units are disposed and connected between the printing platform and the supporting frame respectively and configured to adjust a degree of parallelism between the printing platform and the horizontal movement plane of the printhead according to the adjusted vertical height values.

In accordance with another aspect of the present invention, there is provided a printing platform adjusting method for a printing platform adjusting system of a three-dimensional printer. The printing platform adjusting system includes a print unit having a printhead, a printing platform, a supporting frame, a distance sensor, a control unit, and a parallelism adjusting set. The printing platform is disposed on the supporting frame. The distance sensor is disposed on the printhead unit. The control unit is connected to the distance sensor, and the parallelism adjusting set includes a plurality of adjusting and fastening units connected between the printing platform and the supporting frame respectively. The printing platform adjusting method includes steps of: driving the printhead to move to the positions above a plurality of detecting points on the printing platform, and detecting a plurality of detected vertical height values corresponding to the vertical height distances between the printhead and the detecting points; receiving the detected vertical height values from the distance sensor, and obtaining a plurality of calculated vertical height values corresponding to the vertical height distances between the printhead and the adjusting and fastening units by the control unit; defining one of the calculated vertical height values as a baseline value, and defining a plurality of vertical height differences between the baseline value and the other calculated vertical height values respectively as a plurality of adjusted vertical height values; and adjusting the printing platform to be parallel to the horizontal movement plane of the printhead according to the adjusted vertical height values.

The above contents of the present invention will become more readily apparent to those ordinarily skilled in the art after reviewing the following detailed description and accompanying drawings, in which:

### BRIEF DESCRIPTION OF THE DRAWINGS

FIG. 1 illustrates a printing platform adjusting module of a three-dimensional printer according to the prior art;

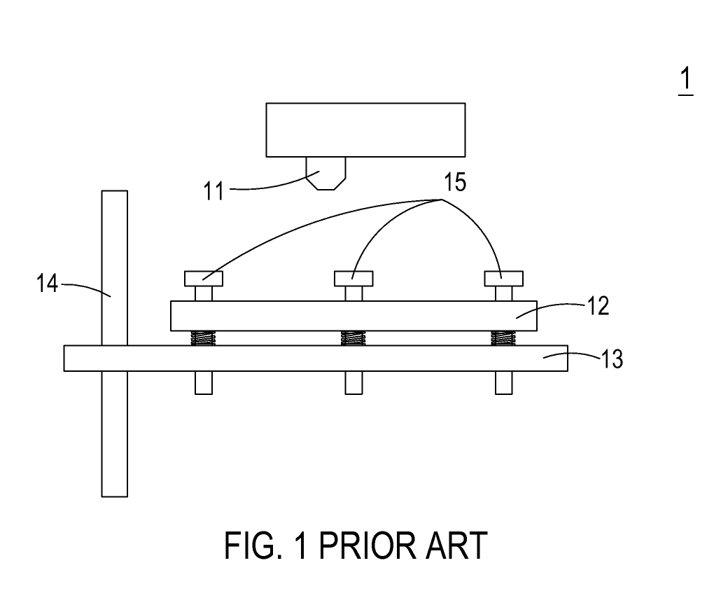

FIG. 2 is a three-dimensional printer having a printing platform adjusting system according to a preferred embodiment of the present invention;

FIG. 3 is a block diagram of a printing platform adjusting system according to the first preferred embodiment of the present invention;

FIG. 4 is a block diagram of a printing platform adjusting system according to the second preferred embodiment of the present invention;

FIG. 5 illustrates detecting points corresponding to the positions of adjusting and fastening units on the printing platform according to a preferred embodiment of the present invention; and

FIG. 6 is a flow chart showing a printing platform adjusting method according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

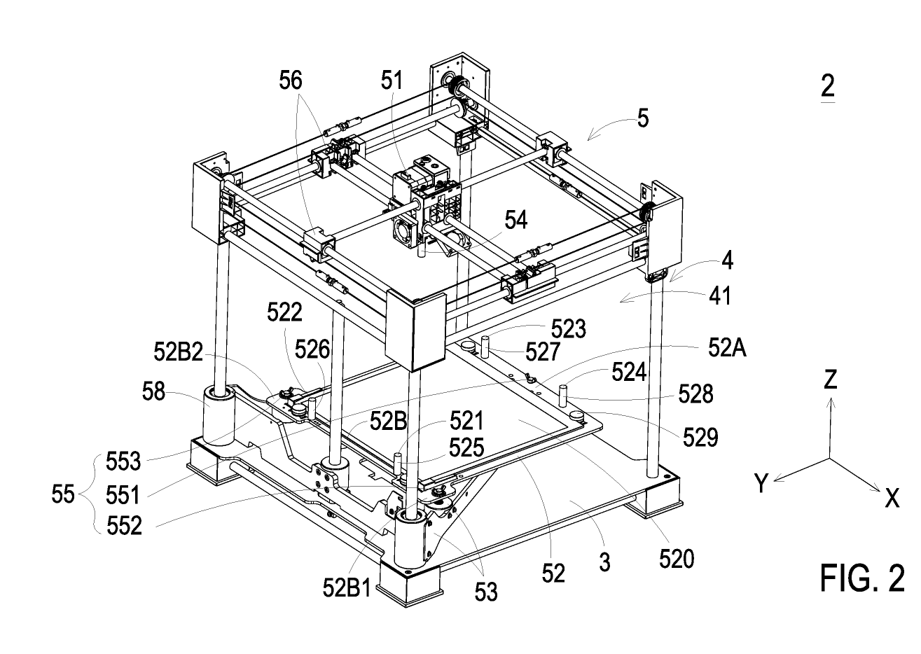

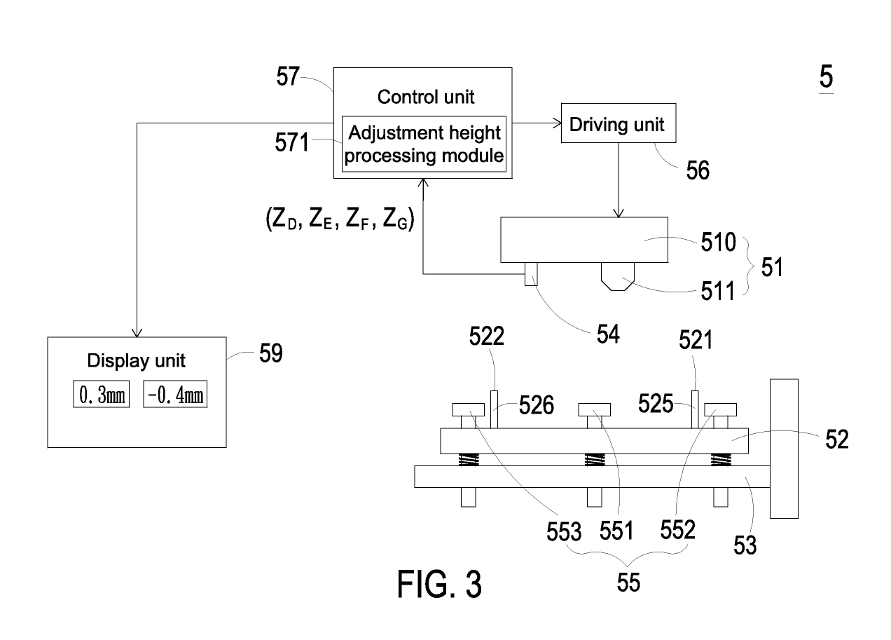

FIG. 2 is a three-dimensional printer having a printing platform adjusting system according to a preferred embodiment of the present invention. FIG. 3 is a block diagram of a printing platform adjusting system according to the first preferred embodiment of the present invention. As shown in FIGS. 2 and 3, the three-dimensional printer 2 includes a base 3, a frame assembly 4, and a printing platform adjusting system 5. The frame assembly 4 is fixed on the base 3 and has a receiving space 41. The printing platform adjusting system 5 comprises a print unit 51, a printing platform 52, a supporting frame 53, a distance sensor 54, a parallelism adjusting set 55, a driving unit 56, and a control unit 57. The print unit 51 includes a carrying body 510 and a printhead 511. The printhead 511 is disposed on the carrying body 510 and configured to extrude molding materials. The printing platform 52 is disposed in the receiving space 41 of the frame assembly 4 and provides a working platform for printing process. The printing platform 52 has a plurality of detecting points 521, 522, 523, 524. The supporting frame 53 is disposed on the base 3 and configured to support the printing platform 52. The distance sensor 54 is disposed on the print unit 51 and configured to detect and obtain a plurality of detected vertical height values corresponding to the detection points 521, 522, 523, 524. The driving unit 56 is connected with the print unit 51 and drives the printhead 511 of the print unit 51 to move selectively in a horizontal movement plane (X-Y transverse plane) and in a vertical direction (Z axis direction). The control unit 57 is connected to the driving unit 56 and the distance sensor 54, and is configured to control the driving unit 56, so that the print unit 51 with the distance sensor 54 driven by the driving unit 56 is moved. In addition, the control unit 57 is configured to detect and obtain the detected vertical height values and convert the detected vertical height values into a plurality of adjusted vertical height values. The parallelism adjusting set 55 comprises a plurality of adjusting and fastening units 551, 552, 553. The adjusting and fastening units 551, 552, 553 are disposed and connected between the printing platform 52 and the supporting frame 53 respectively, and are configured to adjust a degree of parallelism between the print platform 52 and the horizontal movement plane of the printhead 511 according to the adjusted vertical height values.

In an embodiment, the driving unit 56 is a three-axis driving mechanism. The driving unit 56 drives the printhead 511 of the print unit 51 to move in the three-dimensional space by the control of the control unit 57. In some embodiments, the printing platform adjusting system 5 further includes a height adjusting device 58 disposed on the base 3. The supporting frame 53 is movably coupled with the height adjusting device 58, so that the supporting frame 53 is capable of being moved in the vertical direction (i.e. Z-axis direction) for facilitating to adjust the distance between the printing platform 52 and the printhead 511 roughly.

In the embodiment, the detecting points 521, 522, 523, 524 of the printing platform 52 are arranged in a rectangle. The printing platform 52 further includes a plurality of conductive pillars 525, 526, 527, 528. The conductive pillars 525, 526, 527, 528 are metal pillars having the same heights, and the detecting points 521, 522, 523, 524 are disposed on the corresponding ends of the conductive pillars 525, 526, 527, 528, respectively. The conductive pillars 525, 526, 527, 528 of the printing platform 52 are also arranged in a rectangle. In this embodiment, the detecting points 521, 522, 523, 524 disposed on the ends of the conductive pillars 525, 526, 527, 528 form a plane, which is parallel to the surface of the printing platform 52. In some embodiments, the distance sensor 54 is a contact distance sensor or a non-contact distance sensor. The contact distance sensor includes but not limited to a current-type distance sensor. When the distance sensor 54 contacts with the ends of the conductive pillars 525, 526, 527, 528, an electric current can be generated. Consequently, plural detected vertical height values between the printhead 511 and the detecting points 521, 522, 523, 524 can be detected and obtained by distance detector 54. In some embodiment, the non-contact distance sensor includes but not limited to an optical distance sensor including a photo-interrupter with sensor arm, or a light transmitter with a light receiver. Alternatively, the non-contact distance sensor includes but not limited to an inductive proximity sensor. It is noted that the distance sensor 54 is not limited to distance sensor as described in the above embodiments, and is capable of being adjusted and varied according to the practical requirements.

In some embodiments, the printing platform adjusting system 5 further includes a display unit 59 electrically connected to the control unit 57 for displaying the adjusted vertical height values transmitted from the control unit 57. The parallelism adjusting set 55 includes a plurality of adjusting and fastening units, for example a first adjusting and fastening unit 551, a second adjusting and fastening unit 552, and a third adjusting and fastening unit 553. The first adjusting and fastening unit 551 is connected between the printing platform 52 and the supporting frame 53 and disposed on a first side 52A of the printing platform 52. The second adjusting and fastening unit 552 is connected between the printing platform 52 and the supporting frame 53 and disposed on a first end 52B1 of a second side 52B of the printing platform 52, wherein the second side 52B is opposite to the first side 52A. The third adjusting and fastening unit 553 is connected between the printing platform 52 and the supporting frame 53 and disposed on a second end 52B2 of the second side 52B of the printing platform 52, wherein the second end 52B2 is opposite to the first end 52B1.

In this embodiment, the control unit 57 includes an adjustment height processing module 571 configured to receive the detected vertical height values from the distance sensor 54 and convert the detected vertical height values into a plurality of calculated vertical height values so as to obtain detected vertical height values corresponding to the distances between the printhead 511 in the horizontal movement plane and the adjusting and fastening units 551, 552, 553, respectively. For example, the distance sensor 54 obtains four detected vertical height values by detecting the four detecting points 521, 522, 523, 524, and the control unit 57 receives and converts the four detected vertical detected height values into three calculating vertical height values corresponding to the three adjusting and fastening units 551, 552, 553. The calculating vertical height values means the distances between the printhead 511 in the horizontal movement plane and the adjusting and fastening units 551, 552, 553, respectively. Afterward, the adjustment height processing module 571 of the control unit 57 defines one of the three calculated vertical height values as a baseline value, and obtains a plurality of vertical height differences between the baseline value and the other calculated vertical height values, and further defines the vertical height differences as the adjusted vertical height values. For example, the first adjusting and fastening unit 551 is fixed without further adjusting, and the calculated vertical height value of the first adjusting and fastening unit 551 is defined as the baseline value. The vertical height differences between the baseline value and the calculated vertical height values of the second adjusting and fastening unit 552 and the third adjusting and fastening unit 553 are obtained respectively and defined as the adjusted vertical height values. Consequently, the second adjusting and fastening unit 552 and the third adjusting and fastening unit 553 are adjusted respectively according to the corresponding adjusted vertical height values. In this embodiment, the number of the adjusting and fastening units is smaller than the number of the detecting points.

In some embodiments, the first adjusting and fastening unit 551 is a screw, and the second adjusting and fastening unit 552 and the third adjusting and fastening unit 553 are mechanical height-adjusting devices. Each of the second adjusting and fastening unit 552 and the third adjusting and fastening unit 553 has a rotating part and plural marked graduations. The user rotates the rotating part corresponding to the marked graduations for adjusting the clearance between the connection corns of the supporting frame 53 and the printing platform 52. Under this circumstance, the user can rotate and adjust the second adjusting and fastening unit 552 and the third adjusting and fastening unit 553 according to the two adjusted vertical height values shown on the display unit 59 so as to accomplish the process of adjusting the degree of parallelism by means of a semi-automatic method.

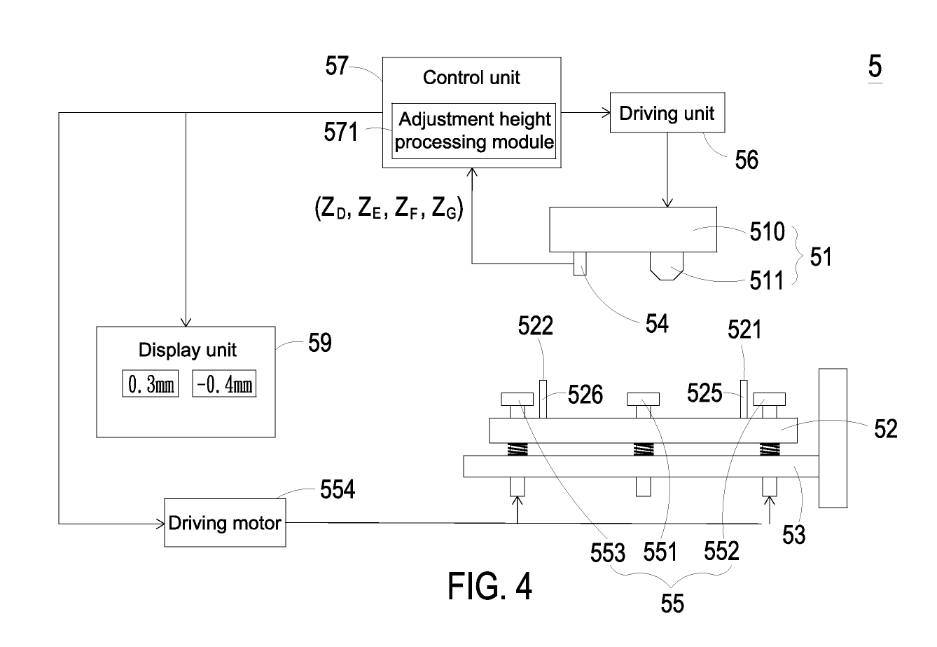

In some embodiment, as shown in FIG. 4, the printing platform adjusting system 5 further includes a driving motor 554 electrically connected with the control unit 57, and mechanically coupled with the second adjusting and fastening unit 552 and the third adjusting and fastening unit 553. The second adjusting and fastening unit 552 and the third adjusting and fastening unit 553 driven by the driving motor 554 are operated by the control of the control unit 57. Consequently, the second adjusting and fastening unit 552 and the third adjusting and fastening unit 553 are adjusted according to the corresponding adjusted vertical height values, and the process of adjusting the degree of parallelism by means of an auto method are accomplished.

In some embodiments, the printing platform adjusting system 5 further includes a glass plate 520 detachably mounted on the printing platform 52 for facilitating the user to take out the injected models or perform a cleaning process. The glass plate 520 is detachably mounted on the printing platform 52 via a plurality of clamping devices 529.

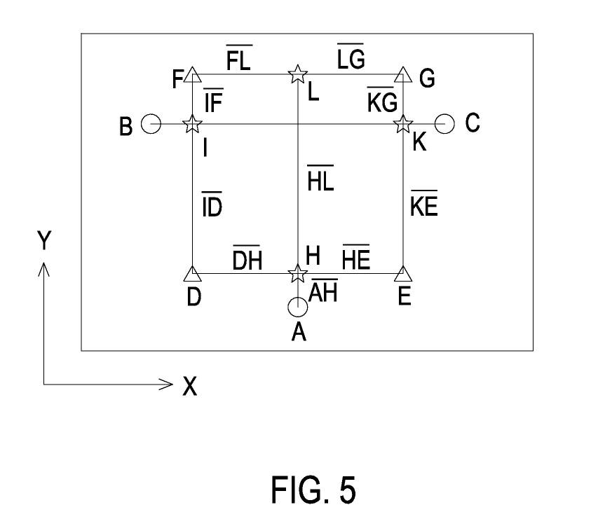

Please refer to FIGS. 2, 3 and 5, wherein FIG. 5 illustrates detecting points corresponding to the positions of adjusting and fastening units on the printing platform according to a preferred embodiment of the present invention. As shown in FIG. 5, points A, B, C respectively represent projected positions of the first adjusting and fastening unit 551, the second adjusting and fastening unit 552 and the third adjusting and fastening unit 553 on the printing platform 52. Points D, E, F, G respectively represent projected positions of the fourth detecting point 524, the third detecting point 523, the first detecting point 521 and the second detecting point 522 (or respectively represent the fourth conductive pillar 524, the third conductive pillar 523, the first conductive pillar 521 and the second conductive pillar 522) on the printing platform 52. Due to that a vertical height value of a third point can be calculated and obtained based on the vertical height values of two known points arranged on the same line (i.e. an interpolation method or an extrapolation method). When the detected vertical height values of the first detecting point 521, the second detecting point 522, the third detecting point 523, and the fourth detecting point 524 are detected and obtained by the distance sensor 54, the calculated vertical height values of the first adjusting and fastening unit 551, the second adjusting and fastening unit 552 and the third adjusting and fastening unit 553 can be calculated and obtained by means of the interpolation method or the extrapolation method.

In detail, the line from point A along the Y-axis has a crossing point H with the line D̅E̅, and has a crossing point L with the line F̅G̅. The line B̅C̅ and the line D̅F̅ have a crossing point I. The line B̅C̅ and the line G̅E̅ have a crossing point K. In FIG. 5, the distance between any two points are represented as A̅H̅, D̅H̅, H̅E̅, I̅D̅, H̅L̅, K̅E̅, B̅I̅, K̅I̅, K̅C̅, I̅F̅, K̅G̅, F̅L̅, L̅G̅, respectively. If the vertical height values between the printhead 511 in the horizontal movement plane and the printing platform 52 is represented as Z, and each point has corresponding vertical height value as Z_{A}, Z_{B}, Z_{C}, Z_{D}, Z_{E}, Z_{F}, Z_{G}, Z_{H}, Z_{I}, Z_{K}, Z_{L}. Z_{F}, Z_{G}, Z_{E}, and Z_{D} are the detected vertical height values of the first detecting point 521, the second detecting point 522, the third detecting point 523, and the fourth detecting point 524 detected and obtained by the distance sensor 54. Z_{A}, Z_{B}, and Z_{C} are the calculated vertical height values of the first adjusting and fastening unit 551, the second adjusting and fastening unit 552 and the third adjusting and fastening unit 553 determined according to the following equations.

Firstly, in the equation (1), Z_{H} is obtained according to the known Z_{D} and Z_{E}.

Z_{H}=(Z_{E}×D̅H̅+Z_{D}×H̅E̅)/(D̅H̅+H̅E̅) (1)

In the equation (2), Z_{L} is obtained according to the known Z_{F} and Z_{G}.

Z_{L}=(Z_{F}×L̅G̅+Z_{G}×F̅L̅)/(L̅G̅+F̅L̅) (2)

In the equation (3), Z_{A} is obtained according to Z_{L} and Z_{H}.

Z_{A}=[(Z_{H}−Z_{L})×A̅H̅/H̅L̅]+Z_{H} (3)

In the equation (4), Z_{I} is obtained according to Z_{F} and Z_{D}.

Z_{I}*(Z_{F}×I̅D̅+Z_{D}×I̅F̅)/(I̅D̅+I̅F̅) (4)

In the equation (5), Z_{K} is obtained according to Z_{G} and Z_{E}.

Z_{K}=(Z_{G}×K̅E̅+Z_{E}×K̅G̅)/(K̅E̅+K̅G̅) (5)

Finally, in the equation (6), Z_{B} is obtained according to Z_{K} and Z_{I}.

Z_{B}=[(Z_{I}−Z_{K})×B̅I̅/K̅I̅]+Z_{I} (6)

Moreover, in the equation (7), Z_{C} is obtained according to Z_{K} and Z_{I}.

Z_{C}=[(Z_{K}−Z_{I})×K̅C̅/K̅I̅]+Z_{K} (7)

According to approach described above, after the detected vertical height values Z_{F}, Z_{G}, Z_{E}, Z_{D} of the first detecting point 521, the second detecting point 522, the third detecting point 523, and the fourth detecting point 524 are detected and obtained, the calculated vertical height values Z_{A}, Z_{B}, Z_{C} of the first adjusting and fastening unit 551, the second adjusting and fastening unit 552 and the third adjusting and fastening unit 553 are determined and obtained by means of the above calculations. Consequently, the degree of parallelism between the printing platform 52 and the horizontal movement plane of the printhead 511 is adjusted according to the calculated vertical height values Z_{A}, Z_{B}, Z_{C} of the first adjusting and fastening unit 551, the second adjusting and fastening unit 552 and the third adjusting and fastening unit 553.

In some embodiments, the first adjusting and fastening unit 551 is fixed without further adjusting, and the calculated vertical height value Z_{A} of the first adjusting and fastening unit 511 is defined as a baseline value. Then, a vertical height difference between the calculated vertical height value (i.e. Z_{A}) of the first adjusting and fastening unit 551 and that (i.e. Z_{B}) of the second adjusting and fastening unit 552, and a vertical height difference between the calculated vertical height value (i.e. Z_{A}) of the first adjusting and fastening unit 551 and that (i.e. Z_{C}) of the third adjusting and fastening unit 553 can be calculated. Afterward, the two vertical height differences are defined as the adjusted vertical height values, and the second adjusting and fastening unit 552 and the third adjusting and fastening unit 553 are adjusted according to the corresponding adjusted vertical height values, respectively. Consequently, the degree of parallelism between the printing platform 52 and the horizontal movement plane of the printhead 511 can be adjusted correspondingly. In other words, when the adjusting process is performed, the first adjusting and fastening unit 551 is fixed without further adjusting, and the second adjusting and fastening unit 552 and the third adjusting and fastening unit 553 are adjusted respectively according to the adjusted vertical height values obtained by means of calculating, so as to accomplish a printing platform adjusting process for adjusting the degree of parallelism between the print platform 52 and the horizontal movement plane of the printhead 511.

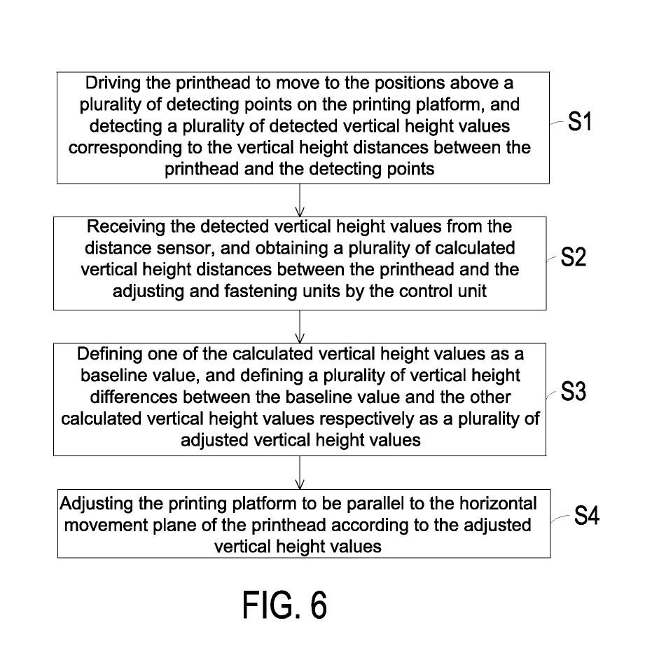

Please refer to FIGS. 2, 3, and 6, wherein FIG. 6 is a flow chart showing a printing platform adjusting method according to the present invention. The printing platform adjusting method includes the following steps. Firstly, the printhead 551 is moved to the positions above the detecting points 521, 522, 523, 524 of the printing platform 52, and a plurality of detected vertical height values corresponding to the vertical height distances between the printhead 551 and the detecting points 521, 522, 523, 524 are detected by the distance sensor 54 (see step S1). Then, a plurality of calculated vertical height values corresponding to the vertical height distances between the printhead 511 and the adjusting and fastening units 551, 552, 553 are obtained according to the detected vertical height values (see step S2). Afterward, one of the calculated vertical height values is defined as a baseline value, and a plurality of vertical height differences between the baseline value and the other calculated vertical height values are obtained respectively and further defined as a plurality of adjusted vertical height values (see step S3). Finally, the printing platform 52 is adjusted to be parallel to the horizontal movement plane of the printhead 551 according to the adjusted vertical height values, so as to accomplish a printing platform adjusting process for the degree of parallelism between the print platform 52 and the horizontal movement plane of the printhead 551 (see step S4). In an embodiment, after the step S3, the method further comprises a step of showing the adjusted vertical height values on the displaying unit 59. In some embodiments, in the step S4, the method further comprises a step of controlling the driving motor 554 to operate by the control unit 57, and performing the adjusting operation by the adjusting and fastening units according to the adjusted vertical height values.

In summary, the present invention provides a printing platform adjusting system of three-dimensional printer, and an adjusting method therefor. The inventive adjusting system and adjusting method can replace the prior adjusting means of ocular estimating and manually producing for adjusting a degree of parallelism between the print platform and a horizontal movement plane of the printhead, so as to solve the problems of complicated adjusting means, time-wasting adjusting process, and imprecise adjusting result, and further avoid to cause damage to the printed product or even to the printhead. By using the adjusting system and adjusting method of the present invention, the degree of parallelism between the printing platform and the horizontal movement plane of the printhead is adjusted automatically or semi-automatically, so that the adjusting process is simplified, the adjusting time period is reduced, and the accuracy and precision of the adjustment operations is enhanced. In addition, the damage probability of printhead can be reduced and the quality of the printed models can be enhanced. Consequently, the entire process of calculating the adjusting parameters is simplified and the loading of the control unit is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing platform adjusting system for a three-dimensional printer, the printing platform adjusting system comprising:
a print unit having a printhead;
a supporting frame;
a printing platform disposed on the supporting frame and having a plurality of detecting points;
a driving unit connected to the print unit and drives the printhead to move in a horizontal movement plane and in a vertical direction;
a distance sensor disposed on the print unit and configured to detect and obtain a plurality of detected vertical height values corresponding to the detecting points;
a control unit connected to the driving unit and the distance sensor, controlling the driving unit to drive the printhead to move, receiving the detected vertical height values from the distance sensor, and converting the detected vertical height values into a plurality of adjusted vertical height values; and
a parallelism adjusting set comprising a plurality of adjusting and fastening units, wherein the adjusting and fastening units are disposed and connected between the printing platform and the supporting frame respectively and configured to adjust a degree of parallelism between the printing platform and the horizontal movement plane of the printhead according to the adjusted vertical height values.

2. The printing platform adjusting system according to the claim 1, further comprising a display unit connected to the control unit for displaying the adjusted vertical height values.

3. The printing platform adjusting system according to the claim 1, wherein the printing platform comprises a plurality of conductive pillars, and the detecting points are disposed on the ends of the conductive pillars, respectively.

4. The printing platform adjusting system according to the claim 1, wherein the distance sensor is a contact distance sensor or a non-contact distance sensor, wherein the distance sensor is moved above the detecting points by the driving unit, and configured to detect a plurality of vertical height distances between the printhead and the corresponding detecting points and obtain the detected vertical height values corresponding to the detecting points.

5. The printing platform adjusting system according to claim 1, wherein the parallelism adjusting set comprises:
a first adjusting and fastening unit connected between the printing platform and the supporting frame and disposed on a first side of the printing platform;
a second adjusting and fastening unit connected between the printing platform and the supporting frame and disposed on a first end of a second side of the printing platform, wherein the second side is opposite to the first side; and
a third adjusting and fastening unit connected between the printing platform and the supporting frame and disposed on a second end of the second side of the printing platform, wherein the second end is opposite to the first end.

6. The printing platform adjusting system according to claim 1, wherein the control unit further comprises an adjustment height processing module configured to receive the detected vertical height values and convert the detected vertical height values into a plurality of calculated vertical height values according to the vertical heights between the printhead in the horizontal movement plane and the adjusting and fastening units.

7. The printing platform adjusting system according to claim 6, wherein the adjustment height processing module of the control unit defines one of the calculated vertical height values as a baseline value, and obtains a plurality of vertical height differences between the baseline value and the other calculated vertical height values, and further defines the vertical height differences as the adjusted vertical height values.

8. The printing platform adjusting system according to claim 1, wherein the number of the adjusting and fastening units is smaller than the number of the detecting points.

9. The printing platform adjusting system according to claim 1, further comprising a driving motor connected between the control unit and two of the adjusting and fastening units, wherein the driving motor controlled by the control unit drives the two adjusting and fasten units to operate so as to perform the adjusting operation according to the adjusted vertical height values.

10. The printing platform adjusting system according to claim 1, further comprising a glass plate detachably mounted on the printing platform.

11. A printing platform adjusting method for a printing platform adjusting system of a three-dimensional printer, wherein the printing platform adjusting system comprises a print unit having a printhead, a printing platform, a supporting frame, a distance sensor, a control unit, and a parallelism adjusting set, the printing platform is disposed on the supporting frame, the distance sensor is disposed on the print unit, the control unit is connected to the distance sensor, the parallelism adjusting set includes a plurality of adjusting and fastening units connected between the printing platform and the supporting frame respectively, the printing platform adjusting method comprises steps of:
(a) driving the printhead to move to the positions above a plurality of detecting points on the printing platform, and detecting a plurality of detected vertical height values corresponding to the vertical height distances between the printhead and the detecting points;
(b) receiving the detected vertical height values from the distance sensor, and obtaining a plurality of calculated vertical height values corresponding to the vertical height distances between the printhead and the adjusting and fastening units by the control unit;
(c) defining one of the calculated vertical height values as a baseline value, and defining a plurality of vertical height differences between the baseline value and the other calculated vertical height values as a plurality of adjusted vertical height values; and
(d) adjusting the printing platform to be parallel to the horizontal movement plane of the printhead according to the adjusted vertical height values.

12. The printing platform adjusting method according to claim 11, wherein the printing platform adjusting system further comprises a display unit connected to the control unit, and the step (c) further comprises a step of showing the adjusted vertical height values on the display unit.
